(19) United States
(12) Patent Application Publication
(10) Pub. No.: US 2016/0311128 A1
(43) Pub. Date: Oct. 27, 2016

(54) Jig for making multiple angled joints and finger joint cuts in wood

(71) Applicant: Ronald Earl Klein, Juneau, AK (US)

(72) Inventor: Ronald Earl Klein, Juneau, AK (US)

(21) Appl. No.: 14/695,388

(22) Filed: Apr. 24, 2015

(51) Int. Cl. B27F 1/16; B27F 1/12

(52) U.S. Cl. CPC B27F 1/16; B27F 1/12

(57) ABSTRACT

This device consists of a sled and clamp system also known as a jig that when used on a conventional table saw or a router table with a miter slot groove, enables the operator to make finger cuts in the form of box, dovetail, and other various wood joints with the appropriate cutting tool.

The sled is fitted with a pivoting fence that allows multiple angles to be created. For example a box containing six sides with finger joints can be made because the main fence is capable of adjusting to the 30 degree angle needed for a tight joint. The sled also has a vertical fence that can be adjusted so joints are formed in a 90 degree relation to the main fence position. The material being cut is aligned to the saw blade or router bit by using a digital readout and threaded rod to adjust the movement of the fence in relation to the cutters. The jig has various clamp arrangements that allow for big or very small pieces of material to be firmly and safely held to the sled.

### BACKGROUND OF THE INVENTION

The use of finger joints in woodworking is a mainstay for connecting two pieces of lumber for the purpose of making boxes, drawers, or forming longer boards. The use of this type of joint is considered the strongest over other wood joints as it provides the most surface area for gluing.

Although it is possible but quite difficult to make finger joints with hand tools, the common approach is to use power equipment such as a table saw or router. Most woodworkers making this type of joint have utilized dado blades on a table saw and by positioning the wood to be cut over an indexing pin on a movable fence. After being cut, each finger in the joint is positioned over the indexing pin to provide the correct spacing for the next cut. Patents exist that utilize a more complex system of spacing with multiple indexing points on a fixed plate to provide correct positioning of the material to be cut. Another option has been to use a router and a template that allows the router cutter to make the correct spacing for the joint.

This invention takes another approach to creating the accurate spacing needed for this type of joinery. The concept is to move the material to be cut and the clamping system with the use of a threaded rod and a digital readout to measure the distance traveled. The Threaded rod is like the lead screw on a metal lathe that moves the lathe carriage horizontally on the lathe bed. The use of a hand crank or stepper motor can be used to power this invention. Multiple angles can be cut using said invention because the clamping system is designed so the fence supports can be pivoted. The clamps used in various combinations allow for tight control of big or small pieces being cut.

Opperation

The sled is first positioned onto the table saw or router table utilizing the miter gauge slots located on most commercial table saws and some router tables. A custom router table could be fabricated to use the jig. The bottom of the sled has two guide bars that position the sled so no side motion is created when the sled is pushed. These guide bars are adjustable to fit different saw table manufacturer's specifications. The machine used to make the cut is then adjusted to the proper height. A test cut with scrap material is then made to check the height and also determine the exact width of the cut. The known width of the cutter is needed to calculate the final cut width.

The material to be cut is then placed in the said jig and secured with the clamp system. With all power off, the work piece edge is positioned against the cutter for the purpose of zeroing the digital readout or a computer controlled stepper motor. Then the sled is moved by hand to a start position. Cuts are made by moving the sled across the cutter table, then advancing the fence clamping system to a known position and repeating the operation until all cuts are made.

The main fence used to hold the wood being cut can swing allowing the operator to make joints that are less than or greater than 90 degrees. For example a box with only three sides or a similar box with more than four sides can be constructed. As well the vertical fence on the jig can also pivot which makes finger jointed angled cuts possible in a perpendicular relation to the main fence. Examples of this cut would be a mitered joint with the diagonal cut composed of fingers, or a box that is tapered from top to bottom with vertical box type joints.

### DETAILED DESCRIPTION OF DRAWINGS

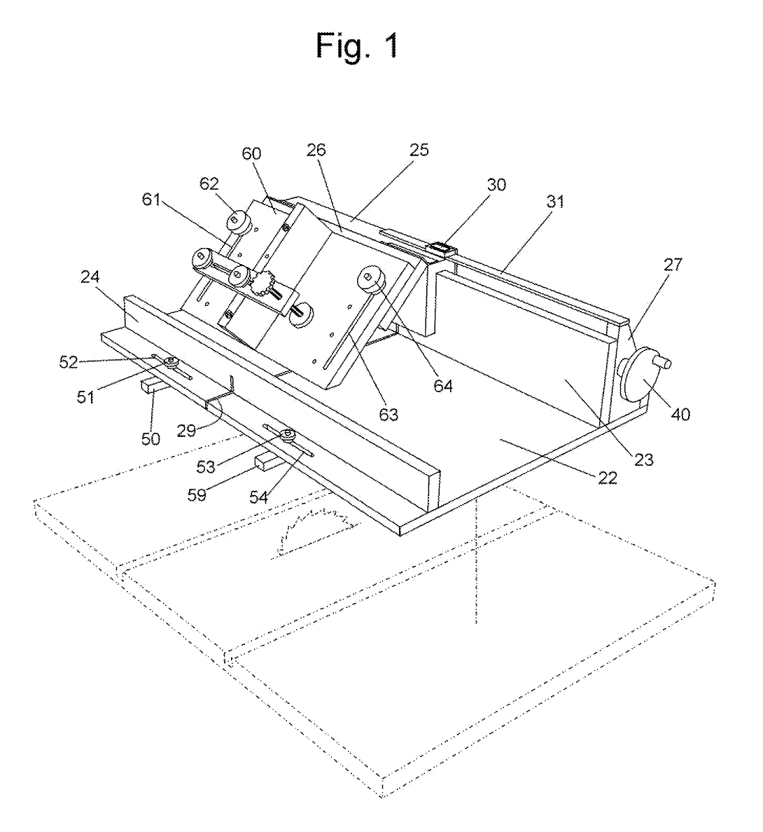

FIG. 1:

Said invention is shown how it is positioned on a table saw. The bed (22) is mated to the grooves of the table saw or router table with guide bars (50, 59). The guide bars are adjusted to the table saw or router grooves by adjusting the front locking nuts (51, 53). The guide bars can be adjusted left or right in slots (52,54) to align the main clearance slot (29) with the table saw or router cutting tool. The main fence table (60) is positioned up or down and locked in place to the pivoting support (26) with locking nuts (62,64). The sliding support (25) moves across the main fixed support (23) and is incrementally measured by the digital readout sensor(30) as the sensor moves across the digital readout bar (31).

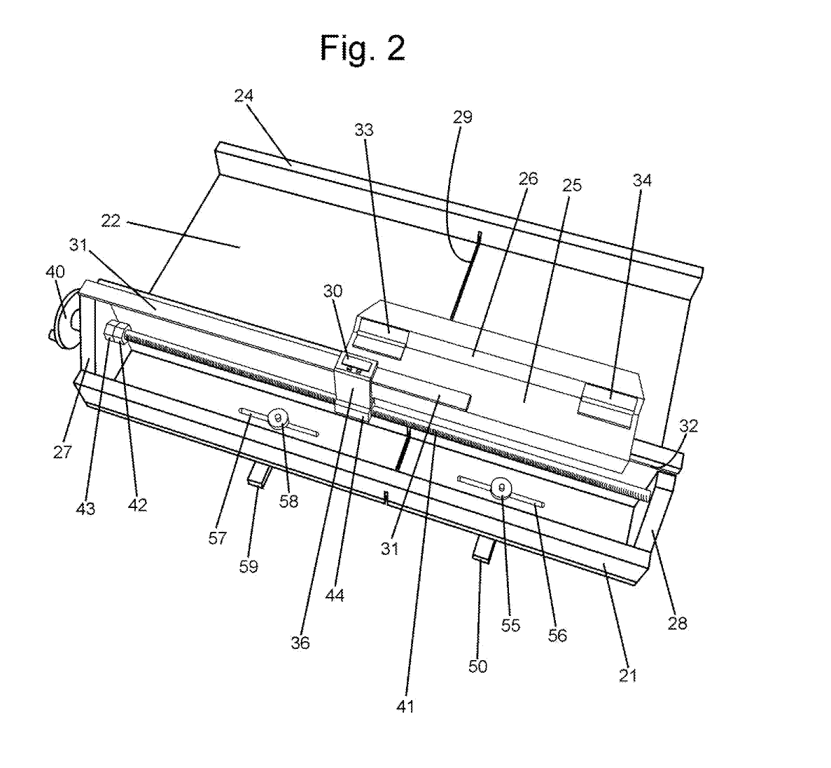

FIG. 2:

Said invention as seen from the rear. Crank handle (40) is shown attached to lead screw (41). The lead screw passes through bearing holes in the side fixed supports (27, 28). Jam nuts (42, 43) prevent lateral end play on the lead screw. A bracket (36) connects the lead screw main nut (44) to the sliding support (25) and the digital readout sensor (30). Hinges (33, 34) allow the pivoting support (26) to swing while connected to the sliding support (25). The digital readout guide bar (31) is fixed to the left side fixed support (27).

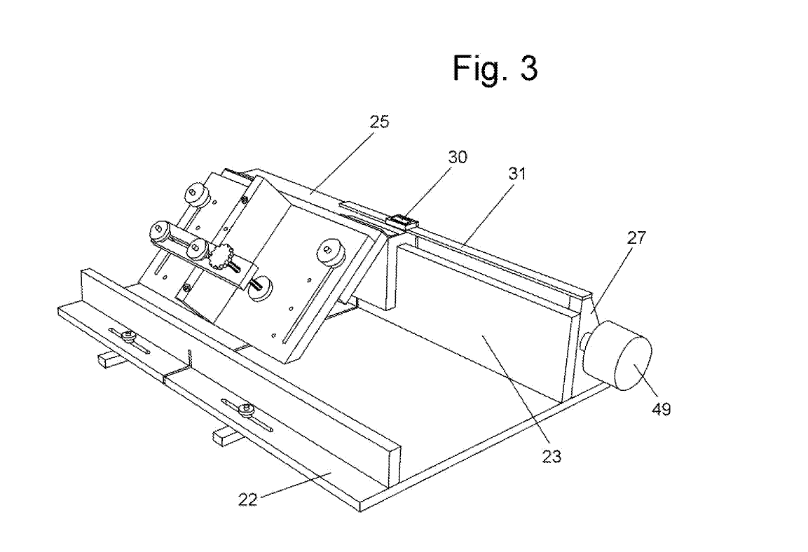

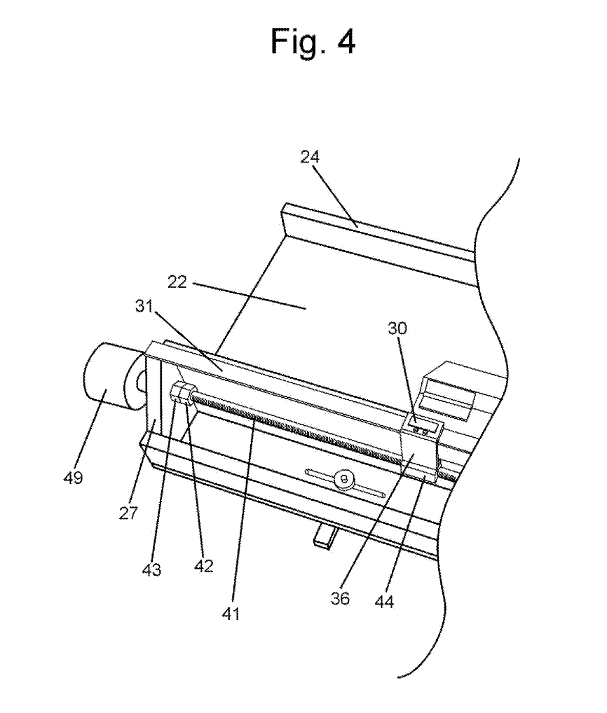

FIGS. 3 and 4:

Shows the placement of a stepper motor (49) to control the movement of the lead screw (41).

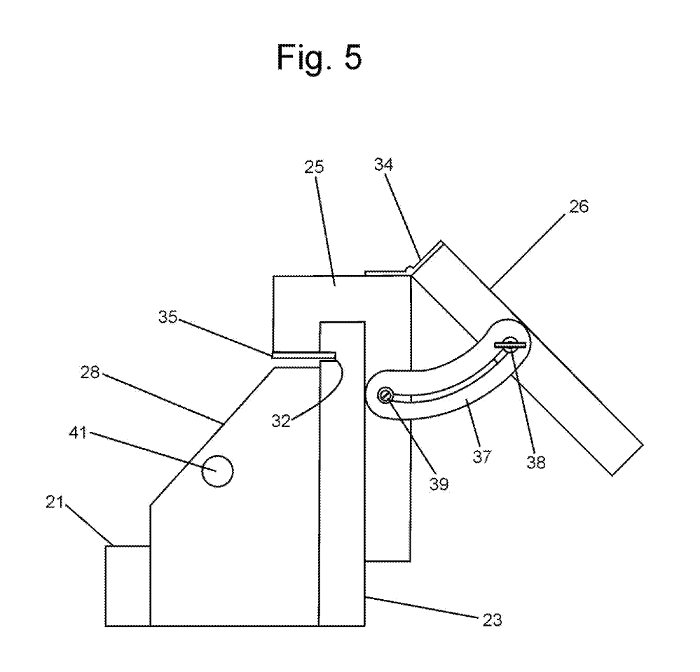

FIG. 5:

Right side view showing how sliding support (25) is kept in place on the main fixed support (23). Bar (35) prevents the sliding support (25) from rising by loosely fitting in groove (32). The right side fixed support (28) has a bearing hole to support the lead screw (41). An angle brace (37) is attached to the sliding support (25) so motion is allowed with angle brace screw (39). The angle brace wing nut (38) locks the angle brace (37) to the pivoting support (26) at the joint angle needed by the operator.

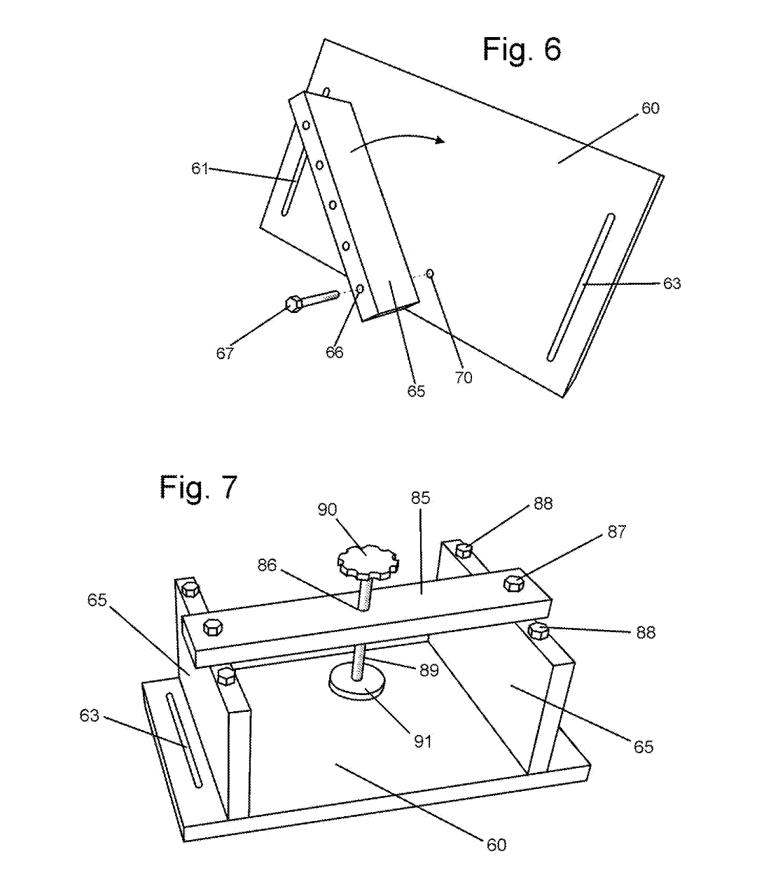

FIG. 6:

Shows how the vertical fence (65) can rotate on the main fence table (60) with the use of a vertical fence bolt (67).

FIG. 7:

Shows how the main fence table (60) can be configured with two vertical fences (65) and a cross bar (85) with clamp screw assembly (89, 90, 91). This is to provide secure mounting of large material being cut with the jig.

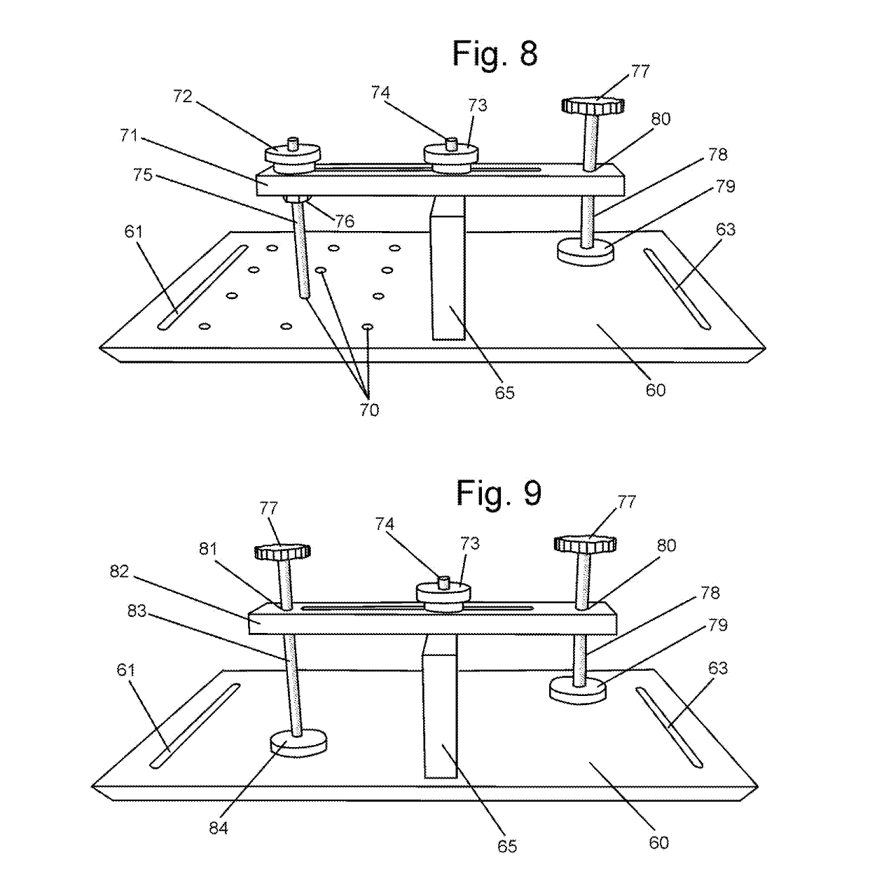

FIG. 8:

Shows the main fence table (60) with a clamping attachment comprising of a vertical fence (65), screw clamp assembly (77, 78, 79), clamp bar (71), clamp bar stud assembly (72, 75, 76), and vertical fence screw stud with locking nut (73, 74). The clamp bar stud is screwed into one of the threaded holes (70) on the main fence table (60).

FIG. 9:

Shows the main fence table (60) with a clamping attachment comprising of a vertical fence (65), screw clamp assembly (77, 78, 79), clamp bar (82), Clamp bar thrust screw assembly (83, 84, 77) passes through a threaded hole (81) in the clamp bar (82) The vertical fence screw stud with locking nut (73, 74) holds the clamp bar to the vertical fence (65).

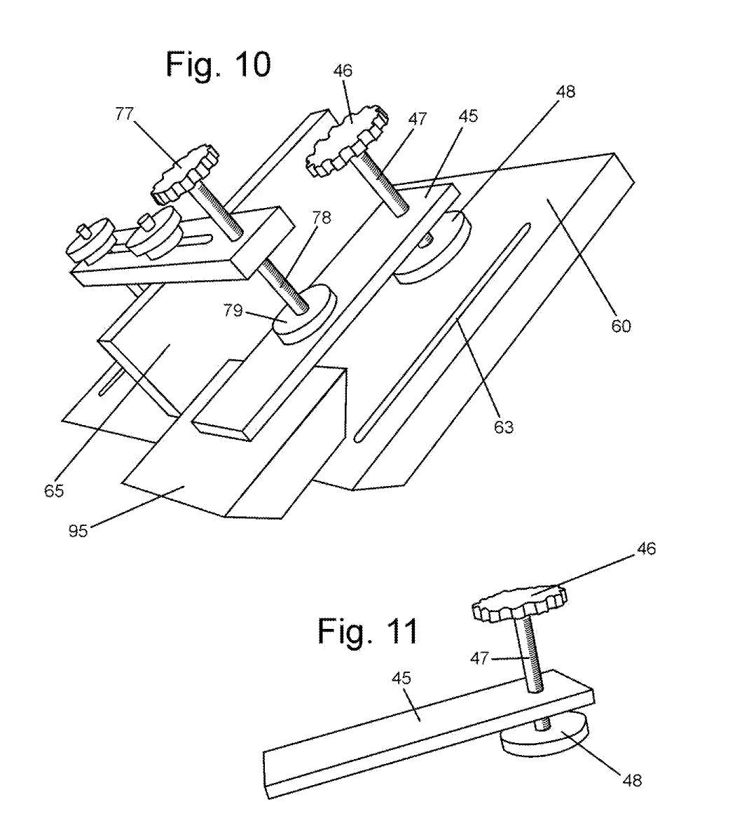

FIG. 10:

Shows a clamping assembly configured to hold material (95) in a safe manner that is very small or short. The use of a spring board clamp assembly (45, 46, 47, 48) added to the main clamp assembly makes this possible.

FIG. 11:

Shows only the spring board clamp assembly (45, 46, 47, 48)

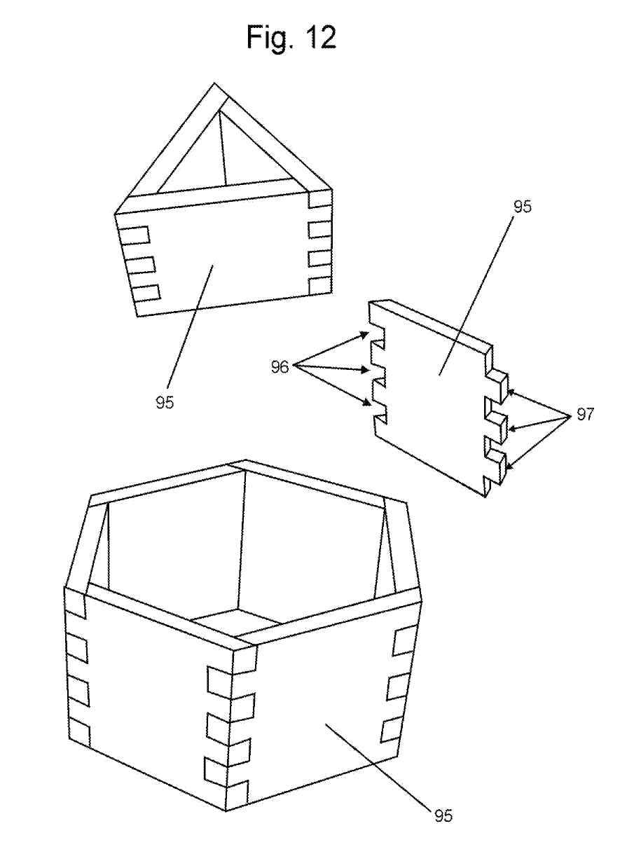

FIG. 12:

Shows how wood pieces (95) can be assembled either as a triangular form or reversed to make a hexagonal form. The purpose of this figure is to help explain there is no need to go past 45 degrees of pivot to achieve any angle of cut. Forty-five degrees will make an eight sided box, all other number of sides can be made with an angle of less than this number of degrees.

1. A jig for cutting joints on a table saw comprising:
a table saw with one or more cutting blades, a pair of guide grooves in the upper surface of the saw table;
jig bed with fixed lateral supports;
side supports drilled for lead screw passage and fixed to jig bed;
slot in jig bed;
guide bars fitted to the guide grooves and attached to a jig bed;
locking nuts and bolts for locking guide bars to jig bed;
a siding support resting on a lateral fixed support;
a lead screw with lead screw nut;
a digital read out attached to one side support on jig bed;
a bracket connecting a digital read out to a lead screw nut;
jam nuts to prevent end play in lead screw attached to lead screw at the point where it passes through jig side bracket;
a crank handle attached to lead screw;
a pivoting support with slots fixed to a sliding support with hinges;
an angle brace attached to a pivoting support and sliding support;
a clamping system attaching to a pivoting support.

2. A jig for cutting joints with a router comprising:
a router with suitable cutter attached to a router table with a pair of guide grooves in the upper surface of the router table;
jig bed with fixed lateral supports;
side supports drilled for lead screw passage and fixed to jig bed;
slot in jig bed;
guide bars fitted to the guide grooves and attached to a jig bed;
locking nuts and bolts for locking guide bars to jig bed;
a siding support resting on a lateral fixed support;
a lead screw with lead screw nut;
a digital read out attached to one side support on jig bed;
a bracket connecting a digital read out to a lead screw nut;
jam nuts to prevent end play in lead screw attached to lead screw at the point where it passes through jig side bracket;
a crank handle attached to lead screw;
a pivoting support with slots fixed to a sliding support with hinges;
an angle brace attached to a pivoting support and sliding support;
a clamping system attaching to a pivoting support.

3. A jig for cutting box joints on a table saw comprising:
a table saw with one or more cutting blades, a pair of guide grooves in the upper surface of the saw table;
jig bed with fixed lateral supports;
side supports drilled for lead screw passage and fixed to jig bed;
slot in jig bed;
guide bars fitted to the guide grooves and attached to a jig bed;
locking nuts and bolts for locking guide bars to jig bed;
a siding support resting on a lateral fixed support;
a lead screw with lead screw nut;
a digital read out attached to one side support on jig bed;
a bracket connecting a digital read out to a lead screw nut;
jam nuts to prevent end play in lead screw attached to lead screw at the point where it passes through jig side bracket;
a stepper motor attached to a lead screw;
a pivoting support with slots fixed to a sliding support with hinges;
an angle brace attached to a pivoting support and sliding support;
a clamping system attaching to a pivoting support.

4. A jig for cutting joints with a router comprising:
a router with suitable cutter attached to a router table with a pair of guide grooves in the upper surface of the router table;
jig bed with fixed lateral supports;
side supports drilled for lead screw passage and fixed to jig bed;
slot in jig bed;
guide bars fitted to the guide grooves and attached to a jig bed;
locking nuts and bolts for locking guide bars to jig bed;
a siding support resting on a lateral fixed support;
a lead screw with lead screw nut;
a digital read out attached to one side support on jig bed;
a bracket connecting a digital read out to a lead screw nut;
jam nuts to prevent end play in lead screw attached to lead screw at the point where it passes through jig side bracket;
a stepper motor attached to lead screw;
a pivoting support with slots fixed to a sliding support with hinges;
an angle brace attached to a pivoting support and sliding support;
a clamping system attaching to a pivoting support.

5. A clamping system comprising:
a main fence table with slots and threaded holes;
bolts and nuts to attach clamping system to pivoting fence;
a vertical fence attached to a main fence table;
a bolt passing through a vertical fence and attaching to a main fence to allow pivoting;
a clamp bar with clamp screw and opposing screw clamp;
